(19) United States
(12) Patent Application Publication
(10) Pub. No.: US 2014/0133292 A1
(43) Pub. Date: May 15, 2014

(54) COMMUNICATION METHOD AND A NODE DEVICE

(71) Applicant: FUJITSU LIMITED, Kawasaki-shi (JP)

(72) Inventors: Katsuhiko Yamatsu, Fukuoka (JP); Koki Mie, Fukuoka (JP); Yuji Higashihara, Fukuoka (JP); Tatsuya Soneda, Fukuoka (JP)

(73) Assignee: FUJITSU LIMITED, Kawasaki-shi (JP)

(21) Appl. No.: 14/028,810

(22) Filed: Sep. 17, 2013

(30) Foreign Application Priority Data
Nov. 14, 2012 (JP) 2012-250674

(51) Int. Cl. H04L 12/705

(52) U.S. Cl. CPC H04L 45/18
USPC 370/228; 370/400

(57) ABSTRACT

A first node device transmits a first path information frame including first path information that associates a destination node device with a first forwarding destination to which the first node device forwards a data frame destined for the destination node device. A second node device other than the first node device receives the first path information frame. The second node device determines whether a forwarding path includes a loop. The forwarding path is a path from the second node device to the destination node device via the first node device and the first forwarding destination. The second node device stores the first path information upon determining that the forwarding path does not include a loop. The second node device forwards a data frame destined for the destination node device to the first node device on the basis of the first path information.

### CROSS-REFERENCE TO RELATED APPLICATION

This application is based upon and claims the benefit of priority of the prior Japanese Patent Application No. 2012-250674, filed on Nov. 14, 2012, the entire contents of which are incorporated herein by reference.

### FIELD

The embodiments discussed herein are related to a communication method and a node device.

### BACKGROUND

An ad hoc network is highly convenient since a network is dynamically generated when a node device included in the network is added or deleted. Node devices included in an ad hoc network may dynamically form the network by transmitting and receiving a Hello frame to and from other node devices. A Hello frame contains information regarding a source node device that transmits the Hello frame, an identifier of each of destination node devices to which the source node device may transmit a frame, and quality information regarding a path from the source node device to each of the destination node devices.

As a related art, a system is disclosed in which each transfer apparatus exchanges forwarding path information with a predetermined transfer apparatus before each transfer apparatus establishes peer-to-peer communication with the predetermined transfer apparatus. Each transfer apparatus establishes the peer-to-peer communication if the exchanged forwarding path information does not include its own identifier.

In addition, a transmission method is disclosed in which a node device that transmits a frame stores identification information of the frame to be transmitted, identification information of a neighboring node device to which the frame is transmitted, and identification information of a node device in a range within a hop count of 1 from which the frame is received in association with one another. In this method, if identification information of a received frame is the same as the identification information of the transmitted frame, the node device updates transmission feasibility information stored in association with a final destination of the received frame. The transmission feasibility information indicates feasibility of transmission to each of a plurality of neighboring node devices. The node device updates the transmission feasibility information associated with the identification information of the received frame to “un-transmittable”.

Japanese Laid-open Patent Publication No. 2001-244977 and International Publication Pamphlet No. WO2011/013165 disclose related techniques.

When a node device obtains a plurality of paths to a destination node device, the node device selects one of the paths, based on the quality information regarding the paths. The quality information is calculated based on the state of a link included in the path, such as signal strength of the received radio wave between two neighboring node devices. However, even when the node device uses the quality information, it is difficult for the node device to determine whether a loop is included in the path. Accordingly, a loop may be included in a path via a node device selected by the node device as a destination of a frame and, therefore, the communication efficiency may be decreased.

### SUMMARY

According to an aspect of the present invention, provided is a communication method. In the communication method, a first node device transmits a first path information frame including first path information that associates a destination node device with a first forwarding destination to which the first node device forwards a data frame destined for the destination node device. A second node device other than the first node device receives the first path information frame. The second node device determines whether a forwarding path includes a loop. The forwarding path is a path from the second node device to the destination node device via the first node device and the first forwarding destination. The second node device stores the first path information upon determining that the forwarding path does not include a loop. The second node device forwards a data frame destined for the destination node device to the first node device on the basis of the first path information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a communication method according to an embodiment;

FIG. 2 illustrates an exemplary configuration of a node device;

FIG. 3 illustrates an example of a link table;

FIGS. 4A to 4C illustrate examples of a routing table;

FIG. 5 illustrates an exemplary hardware configuration of a node device;

FIGS. 6A and 6B illustrate exemplary formats of frames;

FIG. 7 illustrates an example of a network;

FIG. 8 is a sequence diagram illustrating an exemplary process performed in a first embodiment;

FIG. 9 illustrates examples of paths generated in node devices;

FIG. 10 illustrates an example of a forwarding path of a data frame;

FIG. 11 illustrates an example of forwarding performed when a failure occurs in a node device;

FIG. 12 is a sequence diagram illustrating an exemplary process performed when a forwarding path is changed;

FIG. 13 illustrates an exemplary process performed when it is difficult to forward a frame;

FIG. 14 is a flowchart illustrating an exemplary operation flow performed by a node device;

FIG. 15 is a flowchart illustrating an exemplary operation flow for updating a routing table; and

FIG. 16 is a sequence diagram illustrating an exemplary process performed in a second embodiment.

### DESCRIPTION OF EMBODIMENTS

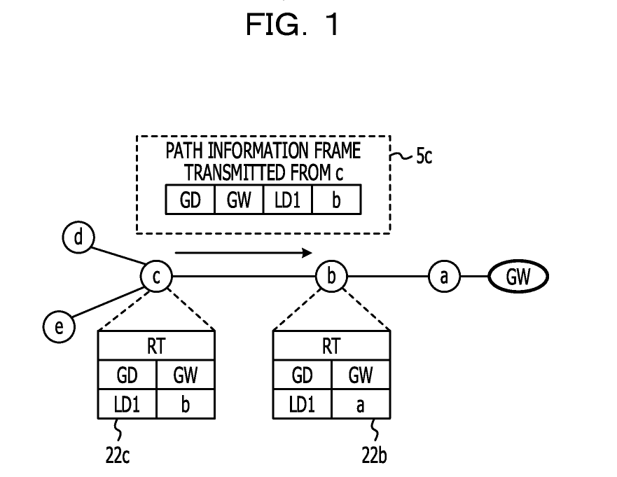

FIG. 1 is a diagram illustrating an example of a communication method according to an embodiment. FIG. 1 illustrates, as an example, an ad hoc network including the following six node devices: nodes “a” to “e” and a gateway apparatus (GW). For ease of understanding, in FIG. 1, any two neighboring node devices are connected using a solid line. Here, a node device “neighbors” a predetermined node device indicates that the node device is located within a range in which the node device may receive a frame transmitted from the predetermined node device. A node device located within a range in which the node device may receive a frame transmitted from a predetermined node device may be referred to as a “neighboring node device” of the predetermined node device.

Each of the node devices included in the ad hoc network acquires path information by transmitting and receiving a path information frame. The path information frame contains an identifier of each of destination node devices to which the source node device of the path information frame may transmit a frame and an identifier of a forwarding destination node device for each of the destination node devices. That is, a source node device of a path information frame notifies, using the path information frame, a neighboring node device of a forwarding destination of a frame for each of the final destinations of frames.

An example of a technique for acquiring path information used in the ad hoc network illustrated in FIG. 1 is described below. In this example, the node “a” is aware, through communication of a path information frame with the GW, that the node “a” neighbors the GW.

(A1) The node “a” notifies, using a path information frame, a neighboring node device that the node “a” may transmit a frame to the GW and the forwarding destination of a frame destined for the GW is the GW.

(A2) Upon receiving the path information frame from the node “a”, the node “b” determines whether a path from the node “b” to the final destination via the node “a” and the forwarding destination notified by the node “a” includes a loop. At that time, if the forwarding destination notified by the node “a” is the same as the final destination, it indicates that the node “a” neighbors the final destination. Accordingly, even when the forwarding destination notified using a path information frame is the same as the final destination, it is determined that a loop is not included in the path.

According to the path information sent from the node “a”, a frame may be transmitted from the node “b” to the GW via the node “a” and, thus, a loop does not appear in the path. Accordingly, the node “b” determines that the frame destined for the GW may be transmitted to the node “a”. The node “b” stores the information sent from the node “a” in a routing table 22b. In the routing table 22b, “GD” represents a “global destination”, and “LD” represents a “local destination”. The “global destination” indicates the final destination of the frame. The “local destination” indicates a node device specified as a destination when one hop transmission is performed in order to transmit the frame to the final destination. That is, a path information frame serves as a message notifying a local destination (LD), in which the node device that has generated the path information frame is specified as a forwarding destination of the frame. Note that “LD1” represents a node device that is preferentially selected as a forwarding destination among a plurality of local destinations.

(A3) Subsequently, the node “b” notifies, using a path information frame, a neighboring node device that the node “b” transmits a frame destined for the GW to the node “a”.

(A4) The node “c” determines, using the path information frame received from the node “b”, whether a loop appears in a path from the node “c” to the GW via the node “b” and the node “a”. Since the node “c” does not find a loop in the target path, the node “c” determines that it may transmit a frame destined for the GW to the node “b”. Thus, the node “c” stores information in a routing table 22c.

(A5) Based on the information in the routing table 22c, the node “c” notifies, using a path information frame 5c illustrated in FIG. 1, a neighboring node device that the node “c” transmits a frame destined for the GW to the node “b”.

(A6) Since the node “b” is a neighboring node device of the node “c”, the node “b” receives the path information frame 5c. Accordingly, the node “b” determines whether a loop appears in a path when the node “b” transmits a frame destined for the GW using the path information received from the node “c”. In this case, the target path reaches the GW via the node “b”, the node “c”, and the node “b”. Accordingly, the path includes a loop. Thus, the node “b” determines that a loop appears between the node “c” and the node “b” if the node “b” transmits a frame destined for the GW to the node “c”. Therefore, the node “b” does not record the path to the GW notified from the node “c” in the routing table 22b.

(A7) When attempting to transmit a frame destined for the GW, the node “b” refers to the routing table 22b and determines the forwarding destination. The routing table 22b does not contain the node “c” as a candidate of the forwarding destination of a frame destined for the GW as a global destination. Accordingly, the node “b” does not transmit the frame to the node “c”. Since the frame transmitted from the node “b” to the GW does not pass through the loop path between the node “b” and the node “c”, the link between the node “b” and the node “c” may be used for other communication.

As described above, in the communication method according to the present embodiment, a node device that has received a path information frame does not use a path, which is found to include a loop, for transmission of a frame. Accordingly, the efficiency of communication in the network may be increased.

While the present embodiment has been described with respect to the operation performed by the node “b”, the node “a” also determines whether the notified path includes a loop in the same manner. Accordingly, upon receiving the path information frame from the node “b” in (A3), the node “a” determines that if the node “a” transmits a frame destined for the GW to the node “b”, the frame returns to the node “a”. Thus, the node “a” does not record the path to the GW notified from the node “b”.

Configuration of Device

In the following example, a Hello frame is used as the path information frame. Note that the path information frame may be any frame that is used for sharing network path information among a plurality of node devices. The Hello frame is an example of the path information frame.

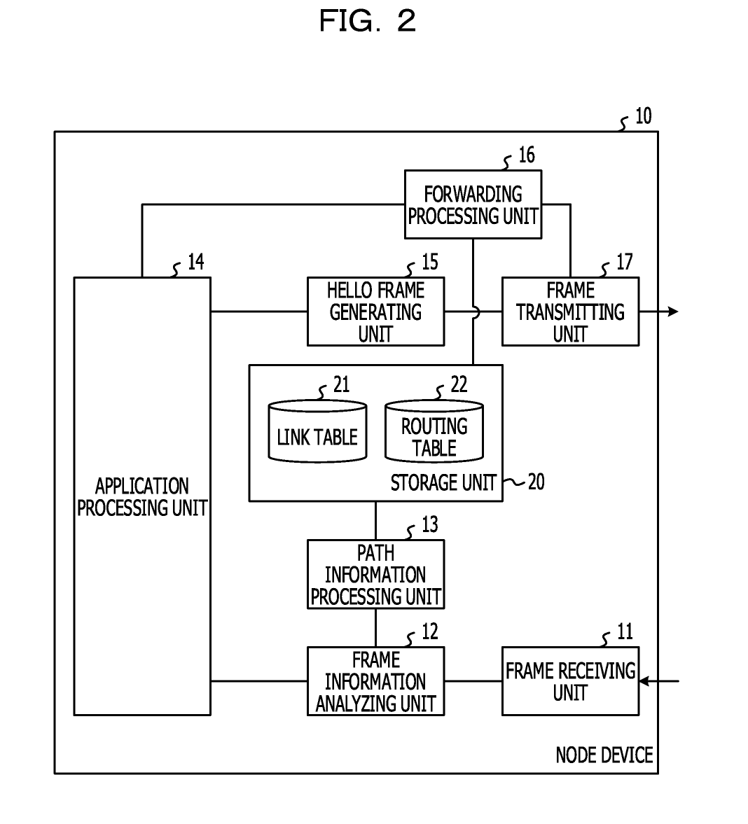

FIG. 2 illustrates an exemplary configuration of a node device 10. The node device 10 includes a frame receiving unit 11, a frame information analyzing unit 12, a path information processing unit 13, an application processing unit 14, a Hello frame generating unit 15, a forwarding processing unit 16, a frame transmitting unit 17, and a storage unit 20. The storage unit 20 stores a link table 21 and a routing table 22. In addition, the storage unit 20 may hold data used for the processing performed by the frame information analyzing unit 12, the path information processing unit 13, the application processing unit 14, the Hello frame generating unit 15, and the forwarding processing unit 16.

The frame receiving unit 11 receives a frame transmitted to the node device 10. The frame receiving unit 11 outputs the received frame to the frame information analyzing unit 12. The frame information analyzing unit 12 examines a frame type field of an ad hoc header included in the input frame. The value in the frame type field varies with the type of frame. For example, the value for a Hello frame differs from the value for a data frame. The frame information analyzing unit 12 may store values in the frame type field corresponding to the types of frame that may be received by the node device 10. The frame information analyzing unit 12 may acquire the values from the storage unit 20 as appropriate. The frame information analyzing unit 12 outputs a Hello frame to the path information processing unit 13 and outputs a data frame to the application processing unit 14.

The path information processing unit 13 acquires an address of a node device 10 that generates the Hello frame and a combination of a global destination address and a local destination address from the Hello frame. The path information processing unit 13 determines whether a loop is included in a path from its own node to the global destination via the source of the Hello frame and the local destination in the combination. When the local destination address in the combination is not an address assigned to its own node, the path information processing unit 13 determines that a loop is not included in the path. At that time, the path information processing unit 13 records the global destination address in the routing table 22 in association with the source of the Hello frame. When the local destination address in the combination is the same as the address assigned to its own node, the path information processing unit 13 determines that a loop is included in the path. In such a case, the path information processing unit 13 does not update the routing table 22 on the basis of the combination of the local destination address and the global destination address. Note that the local destination address and the global destination address included in the combination may be the same. When the local destination address and the global destination address included in the combination are the same, the source of the Hello frame neighbors a node device 10 having the global destination address assigned thereto. Accordingly, even when the local destination address is the same as the global destination address in the combination, the path information processing unit 13 does not determine that a loop is included.

The path information processing unit 13 updates the link table 21 in addition to the routing table 22. In addition, the path information processing unit 13 measures the reception intervals of Hello frame and the signal strengths of the received Hello frames and calculates a value (referred to as a return path link weight) indicating the link state between its own node and the source of the Hello frame. The return path link weight calculated by the path information processing unit 13 indicates the link state in a direction from the source of the Hello frame to its own node. For example, the return path link weight is calculated so as to have a lower value as the reception interval is closer to a theoretical value and as the signal strength of the received Hello frame increases. The path information processing unit 13 stores the reception interval and the signal strength of the Hello frame in the link table 21. Furthermore, the path information processing unit 13 stores the return path link weight notified from the neighboring node device 10 using the Hello frame.

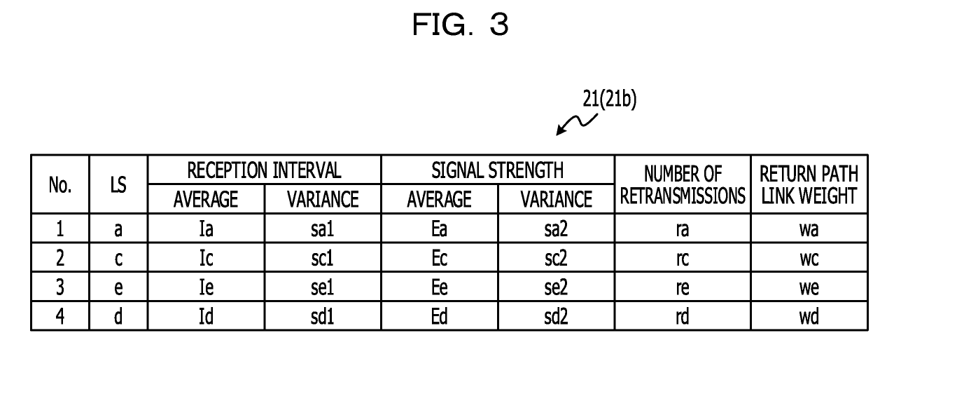

FIG. 3 illustrates an example of the link table 21. In the example illustrated in FIG. 3, the number of data retransmission is stored in association with the source of the Hello frame in addition to the reception interval, the signal strength, and the return path link weight notified from the neighboring node device 10. For each of the reception interval and the signal strength, an average value and a variance value are stored. Note that in FIG. 3, the source of the Hello frame is denoted by an “LS” which is short for a local source. In this case, the local source indicates the node device 10 that has forwarded the frame by one hop. The node device 10 that has generated the frame may be referred to as a global source (GS). Since a Hello frame is broadcast to node devices 10 one-hop distant from the source node device 10, the local source of a Hello frame as well as the global source of a Hello frame is the node device 10 that has generated the Hello frame.

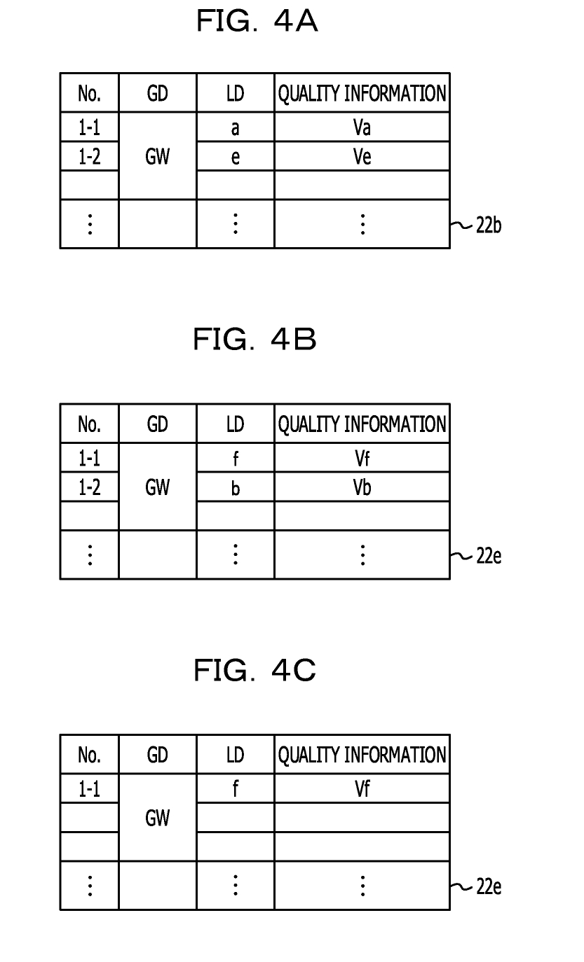

FIGS. 4A to 4c illustrate examples of the routing table 22. A routing table 22 may store any number (at least one) of local destinations for each of the global destinations. In the example illustrated in FIG. 4A, the routing table 22b may store three or less local destinations in association with one global destination. A routing table 22 may also store information indicating the quality of a path for each combination of a global destination and a local destination. The quality of the path is calculated using, for example, the number of hops of the path and the signal strength of each of links included in the path. From among a plurality of techniques for calculating the quality information, appropriate one of the techniques may be selected in accordance with the implementation. A technique for updating the routing table 22 is described later in more detail.

Among frames input from the frame information analyzing unit 12, the application processing unit 14 processes frames destined for its own node in accordance with an application program. If the global destination of the frame input from the frame information analyzing unit 12 indicates another node device 10, the application processing unit 14 outputs the frame to the forwarding processing unit 16. The application processing unit 14 prestores the transmission interval of Hello frame. The application processing unit 14 notifies the Hello frame generating unit 15 of the timing at which a Hello frame is to be generated.

Upon receiving the information regarding the timing at which a Hello frame is to be generated from the application processing unit 14, the Hello frame generating unit 15 generates a Hello frame. The Hello frame is described later in more detail. The Hello frame generating unit 15 outputs the Hello frame to the frame transmitting unit 17.

The forwarding processing unit 16 determines a local destination in accordance with the global destination of the frame input from the application processing unit 14 and generates an ad hoc header. The formats of frames are described later. To determine the local destination, the forwarding processing unit 16 refers to the routing table 22. The forwarding processing unit 16 outputs the frame having the ad hoc header attached thereto to the frame transmitting unit 17. The frame transmitting unit 17 transmits the frame input from the Hello frame generating unit 15 or the forwarding processing unit 16 to the local destination of the frame. For example, since the local destination of a Hello frame is each of all of the neighboring node devices 10, the frame transmitting unit 17 broadcasts the Hello frame.

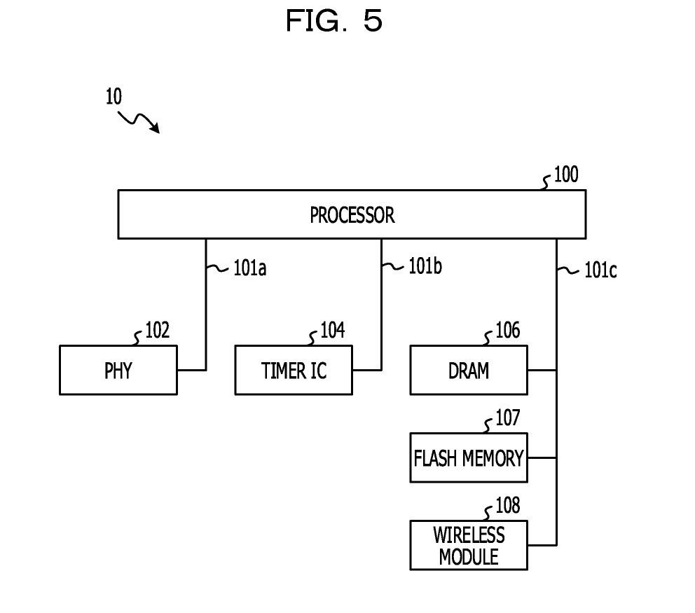

FIG. 5 illustrates an exemplary hardware configuration of the node device 10. The node device 10 includes a processor 100, buses 101 (101a to 101c), a timer integrated circuit (IC) 104, a dynamic random access memory (DRAM) 106, a flash memory 107, and a wireless module 108. The node device 10 may optionally include a PHY chip 102. The buses 101a to 101c connect the processor 100 with the PHY chip 102, the timer IC 104, the DRAM 106, the flash memory 107, and the wireless module 108, so that the processor 100 may input and output data.

The processor 100 may be any processing circuit, such as a microprocessing unit (MPU). The processor 100 reads a program, such as firmware stored in the flash memory 107, and performs processing. At that time, the processor 100 may use the DRAM 106 as a working memory. In the node device 10, the processor 100 functions as the frame information analyzing unit 12, the path information processing unit 13, the application processing unit 14, the Hello frame generating unit 15, and the forwarding processing unit 16. In the node device 10, the DRAM 106 functions as the storage unit 20. The DRAM 106 stores the link table 21 and the routing table 22. In the node device 10, the wireless module 108 functions as the frame receiving unit 11 and the frame transmitting unit 17. The PHY chip 102 is used for wired communication. If the node device 10 functions as a gateway that relays communication data between a device in an ad hoc network and a device in another network, communication over lines may be performed via the PHY chip 102.

The timer IC 104 is used to measure the transmission interval of Hello frame and the reception interval of Hello frame from a neighboring node device 10. That is, the timer IC 104 functions as a part of the path information processing unit 13 and the application processing unit 14.

Note that a program, such as firmware, may be stored in a computer-readable storage medium and be provided. Thereafter, the program may be installed in the node device 10. Alternatively, the program may be downloaded from a network via the PHY chip 102 or the wireless module 108 and be installed in the node device 10. Note that in some embodiment, a storage unit other than the DRAM 106 and the flash memory 107 may be used. The node device 10 may be a computer.

Example of Frame Format

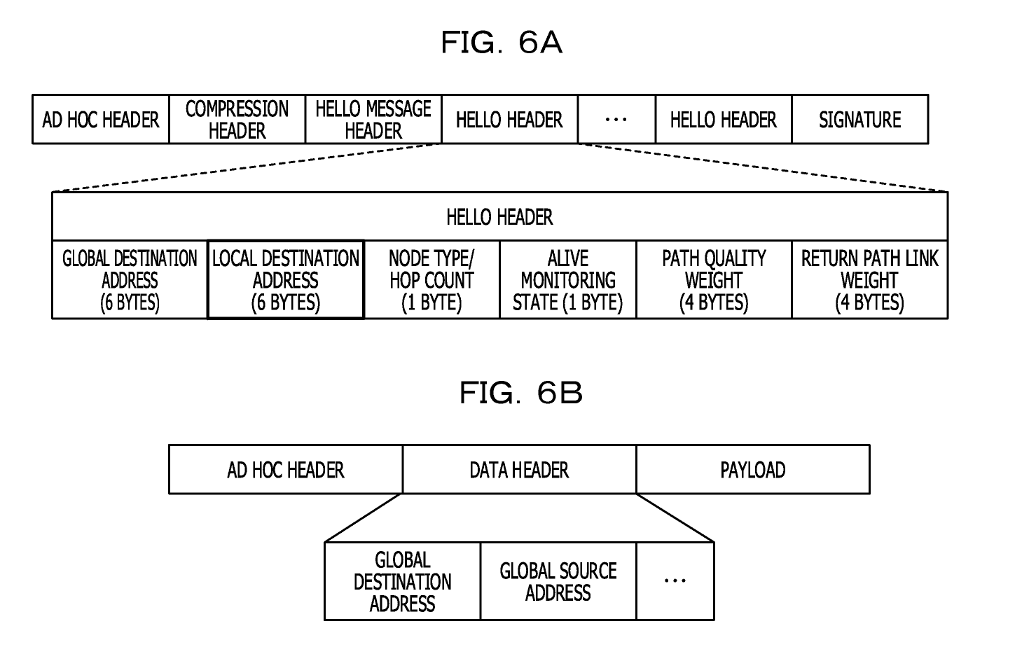

FIG. 6A illustrates an exemplary format of a Hello frame. An ad hoc header of the Hello frame contains information such as a local destination address, a local source address, a type, and a frame size. In the Hello frame, the local destination address is set to a broadcast address that represents all of the neighboring node devices. The local source address of the Hello frame is set to the address assigned to the node device 10 that generates the Hello frame. The type is a value that allows the type of the frame to be uniquely identified.

As illustrated in FIG. 6A, in addition to the ad hoc header, the Hello frame contains information such as a compression header, a Hello message header, a Hello header, and a signature. The compression header includes information regarding compression of data contained in the Hello frame. The Hello message header includes the number of Hello headers. The number of Hello headers is the same as the number of global destinations stored in the routing table 22 of the node device 10 (the source node device 10 of the Hello frame) that transmits the Hello frame.

The Hello header contains a global destination address, a local destination address, a node type, the number of hops, alive monitoring state information, a path quality weight, and a return path link weight. The local destination address indicates the node device 10 serving as a forwarding destination of a frame when the frame is transmitted to the global destination address recorded in the Hello header. If the source node device 10 of the Hello frame has a plurality of paths to the global destination contained in the Hello header, the address of the node device 10 having the highest probability of being used for the forwarding is recorded as the local destination address of the Hello header. For example, assume that the node “b” has, as a path from the node “b” to the GW, the following two paths: a path including the node “a” as a forwarding destination and a path including a node “e” as a forwarding destination. If the communication state of the path including the node “a” as a forwarding destination is better than that of the path including the node “e” as a forwarding destination, the node “b” sets the local destination address to the address of the node “a” in the Hello header containing the global destination set to the GW. In the following description of the local destination, the character string “LD” may have a suffix (a number) indicating the priority of the local destination. For example, if the state of a path from the node “b” to the GW via the node “a” is better than the state of a path from the node “b” to the GW via the node “e”, LD1 is set to the node “a” and LD2 is set to the node “e” for a path including GD=GW.

The hop count field contains the number of hops from the source of the Hello frame to the global destination contained in the Hello header. If a plurality of local destinations are present for one global destination, the number of hops of the path via LD1 is recorded in the Hello header. The node type in the Hello header is used to determine whether a node device specified as the global destination in the Hello header functions as a gateway. The path quality weight is the sum of values reflecting communication performance for all of the links included in the path. The path quality weight is used to calculate the communication quality of the path. Like the hop count field, if a plurality of local destinations are present for one global destination, the value for a path via LD1 is recorded in the Hello header. The return path link weight field is used if the global destination contained in the Hello header indicates a neighboring node device of the source of the Hello frame. The return path link weight field indicates the reception quality of a Hello frame received by the source of the Hello frame from the node indicated by the global destination in the Hello header.

FIG. 6B illustrates an exemplary format of a data frame. The data frame contains an ad hoc header, a data header, and a payload. The information items contained in the ad hoc header are the same as those contained in the Hello frame. The data header contains the global destination address and a global source address of the data frame. The payload contains data to be transmitted and received.

### First Embodiment

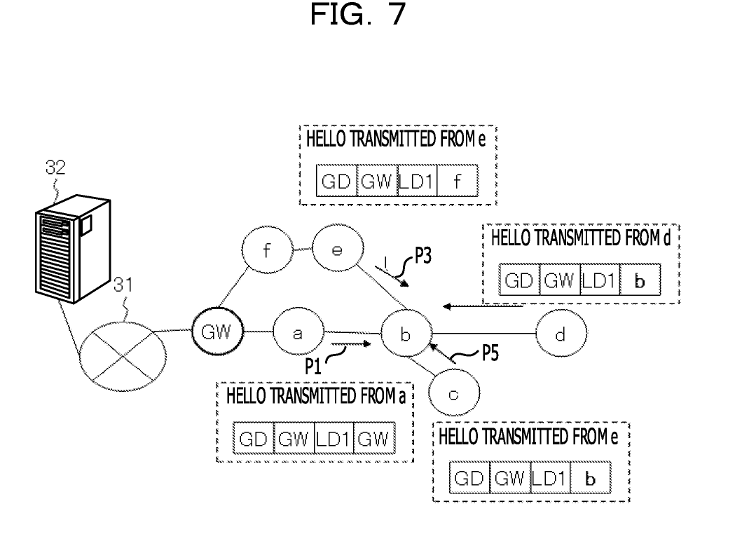

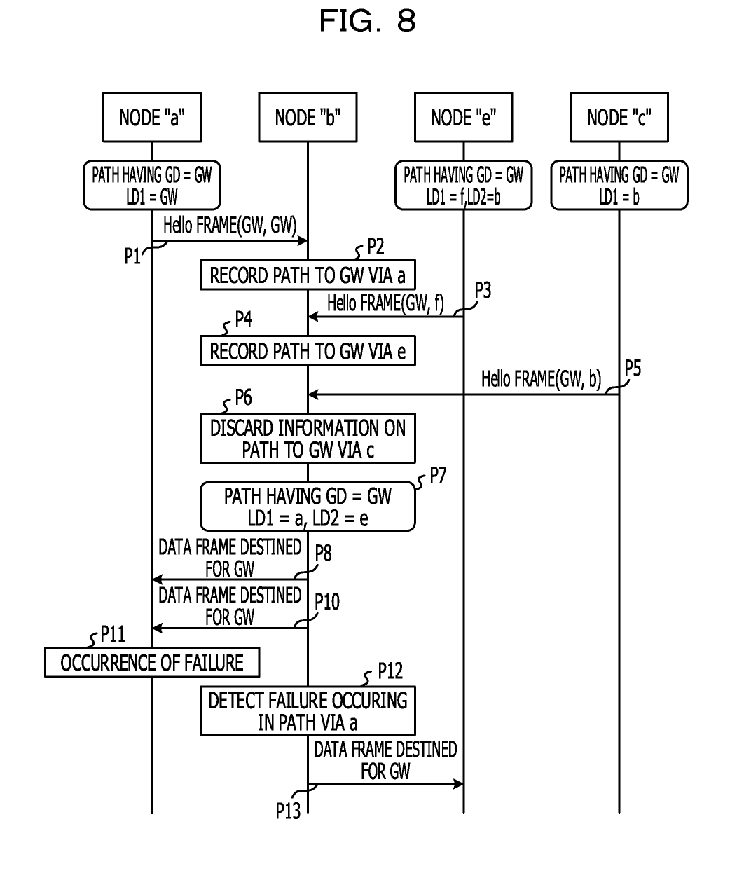

FIG. 7 illustrates an example of a network. FIG. 8 is a sequence diagram illustrating an exemplary process performed in a first embodiment. An example of the process performed when the Hello frame is transmitted and received in the ad hoc network illustrated in FIG. 7 is described below. In the example illustrated in FIG. 7, the ad hoc network is connected to a network 31. The network 31 includes a server 32. A node device 10 included in the ad hoc network may communicate with the server 32 via a node device that functions as a gateway between the network 31 and the ad hoc network.

As illustrated in FIG. 7, since the node “a” neighbors the GW, the node “a” sets the local destination to the GW when the global destination is the GW. The node “e” may set the local destination to each of the node “b” and a node “f” when the global destination is the GW. In this example, it is assumed that the state of a path including the node “f” as the local destination is better than the state of a path including the node “b” as the local destination. That is, in the node “e”, when GD=GW, LD1 is set to the node “f” and LD2 is set to the node “b”. In the node “c” and the node “d”, the local destination is set to the node “b” when the global destination is the GW.

Note that symbols such as P1, P2, and the like described below correspond to the same symbols illustrated in FIGS. 7, 8, and 10. In the following description, to clarify which one of the node devices 10 performs an operation, the reference numeral may have, as a suffix, an alphabetical character that is the same as that assigned to the node device 10 performing the operation. For example, the path information processing unit 13 in the node “b” may be written as a “path information processing unit 13b”.

(P1) An application processing unit 14a in the node “a” requests a Hello frame generating unit 15a to generate a Hello frame. The Hello frame generating unit 15a generates a Hello frame including the following information items:

Source of the Hello frame: node “a”

Global destination in the Hello header: GW

LD1 in the Hello header: GW.

Thereafter, the Hello frame generating unit 15a broadcasts the generated Hello frame via a frame transmitting unit 17a. Accordingly, by using the Hello frame, the node “a” may notify the node devices 10 that neighbor the node “a” that a frame having “GW” as the global destination is transmitted to the GW. In FIG. 8 and the subsequent drawings, a first value in parentheses that follows the words “Hello frame” represents the global destination in the Hello header. A second value in the parentheses represents a node device 10 specified, by the node device 10 that generates a Hello frame, as the local destination of a forwarding frame destined for the global destination indicated by the first value.

(P2) A frame receiving unit 11b in the node “b” outputs the received Hello frame to a frame information analyzing unit 12b. When the frame information analyzing unit 12b determines that the input frame is a Hello frame on the basis of the type value included in the ad hoc header, the frame information analyzing unit 12b outputs the input frame to a path information processing unit 13b. The path information processing unit 13b records the acquired information regarding the source of the Hello frame in a link table 21b. For example, the path information processing unit 13b records, in the link table 21b, the information contained in “No. 1” entry illustrated in FIG. 3 on the basis of the frame received in P1. Note that the return path link weight contained in the “No. 1” entry illustrated in FIG. 3 has been calculated when the node “a” receiving the Hello frame previously broadcasted by the node “b”. Accordingly, the return path link weight recorded in the “No. 1” entry illustrated in FIG. 3 indicates the link state when a frame is transmitted from the node “b” to the node “a”.

The path information processing unit 13b calculates the return path link weight when a frame is transmitted from the node “a” to the node “b”. The return path link weight may be obtained on the basis of, for example, the average value and variance value of the reception intervals of the Hello frame, the average value and variance value of the signal strengths of the Hello frame, and the number of retransmissions of a frame to the source of the Hello frame. The path information processing unit 13b prestores a reference reception interval of the Hello frame. The path information processing unit 13b sets the value of the return path link weight so that the value of the return path link weight decreases as the average value of the reception intervals of the Hello frame is closer to the reference reception interval. In addition, the path information processing unit 13b sets the value of the return path link weight so that the return path link weight decreases as the average value of the signal strengths of the Hello frame increases. Furthermore, the path information processing unit 13b decreases the return path link weight as each of the variance value of the reception intervals of the Hello frame and the variance value of the signal strengths of the Hello frame decreases. The return path link weight decreases as the number of transmissions decreases.

The path information processing unit 13b determines whether a loop is included in a path from the node “b” to the global destination indicated by the Hello header via the source of the Hello frame and the local destination indicated by the Hello header. At that time, the path information processing unit 13b determines whether a loop is included by determining whether the local destination indicated by the Hello header is the node “b”. In this case, since the local destination indicated by the Hello header is the GW, the path information processing unit 13b determines that a loop is not included in the path notified using the Hello header to be processed. Thus, the path information processing unit 13b records the path to the GW via the node “a” in the routing table 22b.

The path information processing unit 13b calculates an evaluation value for the path to the GW via the node “a”. The evaluation value is calculated using the path quality weight indicated by the Hello header and the return path link weight for its own node transmitted from the source of the Hello frame. The path information processing unit 13b determines whether the Hello header containing GD=node “b” is included in the Hello frame transmitted from the node “a”. If the Hello header containing GD=node “b” is included in the Hello frame, the path information processing unit 13b obtains the evaluation value using the return path link weight of the Hello header containing GD=node “b” and the path quality weight of GD=GW. The path information processing unit 13b uses the obtained evaluation value as the quality information regarding the path from the node “b” to the GW via the node “a”. If the path quality weight has a value indicating that the state of the path is relatively good and, in addition, the state of the link with the source of the Hello frame is good, the state of the path notified using the Hello header is relatively good. In this example, as each of the evaluation value, the path quality weight contained in the Hello header, and the link weight of the link with the source of the Hello frame decreases, the state of the path is better. Note that the computation expression of the evaluation value is freely determined in accordance with the implementation. In this case, it is assumed that the path information processing unit 13b records the path indicated by “No. 1-1” illustrated in FIG. 4A.

(P3) In response to a request from an application processing unit 14e, a Hello frame generating unit 15e of the node “e” generates a Hello frame including a Hello header containing the following information regarding a path via the LD1:

Source of the Hello frame: node “e”

Global destination in the Hello header: GW

LD1 in the Hello header: node “f”.

Thus, the node “e” may notify node devices 10 that neighbor the node “e” that the node “e” transmits a frame having the global destination=GW to the node “f”.

(P4) The path information processing unit 13b in the node “b” acquires the Hello frame generated in the node “e” in the same manner as in P2. The path information processing unit 13b records the information regarding the source of the Hello frame in the link table 21b. In this case, it is assumed that the path information processing unit 13b records, in the link table 21b, the information contained in “No. 3” entry illustrated in FIG. 3.

The path information processing unit 13b determines whether a loop is included in a path from the node “b” to the GW via the node “e” and the node “f”. At that time, since the local destination contained in the Hello header including GD=GW is the node “f”, the path information processing unit 13b determines that a loop is not included in the path notified using the Hello header to be processed. Thus, the path information processing unit 13b determines that a frame may be transmitted to the GW via the node “e” and records the path to the GW via the node “e” in the routing table 22b. In this case, it is assumed that the path information processing unit 13b records the path indicated by “No. 1-2” illustrated in FIG. 4A.

(P5) The node “c” generates a Hello frame including a Hello header containing information regarding the path via LD1. Thus, the node “c” may notify node devices 10 that neighbor the node “c” that a frame having the global destination set to the GW is transmitted to the node “b”, using the Hello frame containing the following information items:

Source of the Hello frame: node “c”

Global destination in the Hello header: GW

LD1 in the Hello header: node “b”.

(P6) The path information processing unit 13b in the node “b” acquires the Hello frame generated in the node “c” in the same manner as in P2. The path information processing unit 13b records the information regarding the source of the Hello frame in the link table 21b. In this example, it is assumed that the information indicated by “No. 2” illustrated in FIG. 3 is recorded in the link table 21b.

The path information processing unit 13b determines whether a loop is included in a path from the node “b” to the GW via the node “c” and the node “b”. At that time, since the local destination contained in the Hello header is the node “b”, the path information processing unit 13b determines that a loop is included in the path notified using the Hello header to be processed. Accordingly, in order to avoid recording the path including a loop, the path information processing unit 13b discards the information contained in the Hello frame received from the node “c” without recording the information in the routing table 22b.

Like the node “c”, the node “d” generates a Hello frame having a Hello header containing the global destination set to the GW and LD1 set to the node “b”. Thereafter, the node “d” transmits the generated Hello frame to a node device 10 that neighbors the node “d” (refer to FIG. 7). The node “b” processes the Hello frame received from the node “d” in the same manner as for the Hello frame received form the node “c”. Accordingly, by allowing the node “b” to use the Hello frames generated by the node “a” and the nodes “c” to “e”, the path information processing unit 13b may generate the link table 21b illustrated in FIG. 3 and the routing table 22b illustrated in FIG. 4A.

(P7) The path information processing unit 13b compares the evaluation values of all of the paths for the local destinations recorded in the routing table 22b with one another and assigns priorities in ascending order of the evaluation values. Note that as the priority increases, the number following “LD” decreases.

In this case, if the GW is the global destination, the path information processing unit 13b determines that the path having the node “a” as the forwarding destination is better than the path having the node “e” as the forwarding destination and has a higher priority. Accordingly, the path information processing unit 13b sets LD1 to the node “a” and sets LD2 to the node “e” for the path including GD=GW.

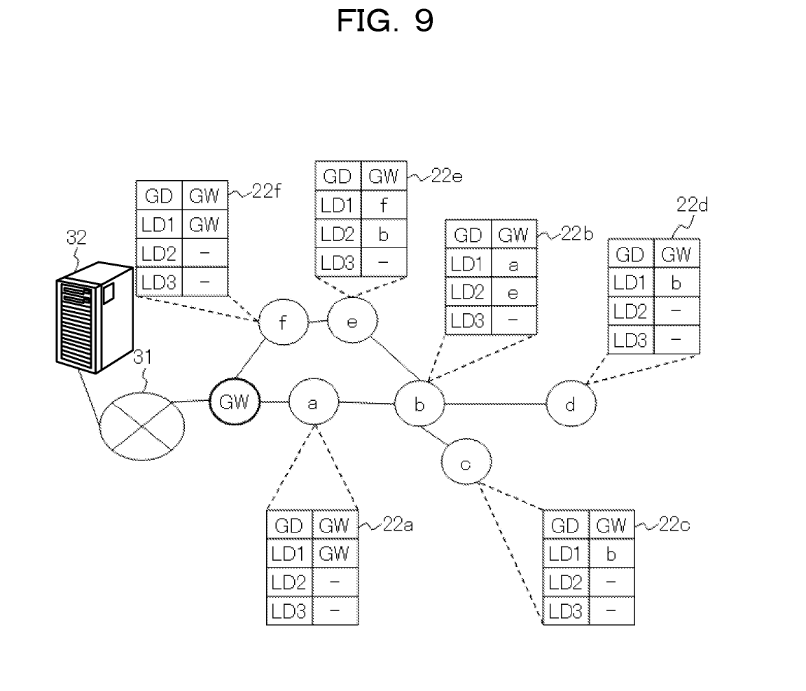

FIG. 9 illustrates examples of paths generated in the node devices 10. Each of the node “a” and the nodes “c” to “f” acquires a path to each of the node devices 10 in the ad hoc network in the same manner as in P1 to P7 illustrated in FIGS. 7 and 8. In the example illustrated in FIG. 9, the local destinations for the path having the global destination set to the GW in the routing table 22 held in the nodes “a” to “f” are illustrated.

In this case, the node “a” records the GW as a local destination in a routing table 22a. In contrast, the node “a” does not record the node “b” as a local destination of a path to the GW. This is because the node “b” broadcasts a Hello frame in which LD1 is set to the node “a”. If the node “a” uses the path notified from the node “b”, the node “a” transmits a frame having the global destination set to the GW from the node “a” to the node “b” and, thereafter, receives the frame from the node “b”. Subsequently, the node “a” transmits the frame to the GW. Accordingly, the node “a” determines that a loop appears if the node “a” transmits the frame from the node “a” using the path notified from the node “b” and, thus, the node “a” discards the path information received from the node “b”. Similarly, the node “f” is notified from the node “e” of the path to the GW in which LD1 is set to the node “f”. Accordingly, the node “f” does not record the node “e” as a local destination of the path to the GW.

(P8) Subsequently, an application processing unit 14b of the node “b” generates data destined for the GW. The application processing unit 14b outputs the generated data to a forwarding processing unit 16b. The forwarding processing unit 16b refers to the routing table 22b and generates a data frame containing the following address information:

Global source: node “b”

Global destination: GW

Local destination: node “a”

Local source: node “b”.

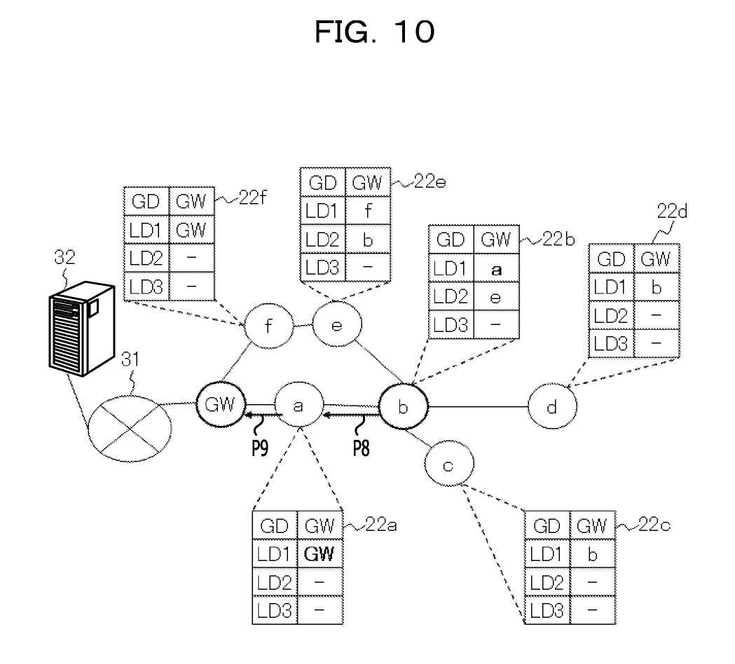

The forwarding processing unit 16b outputs the generated data frame to a frame transmitting unit 17b. As illustrated in FIG. 10, the frame transmitting unit 17b transmits the data frame to the node “a”.

(P9) A frame receiving unit 11a in the node “a” outputs the data frame received from the node “b” to a frame information analyzing unit 12a. The frame information analyzing unit 12a refers to the type of the ad hoc header and outputs the data frame to the application processing unit 14a. Since the global destination is not the node “a”, the application processing unit 14a outputs the data frame to a forwarding processing unit 16a. The forwarding processing unit 16a refers to the routing table 22a and changes the address information in the data frame as follows:

Global source: node “b”

Global destination: GW

Local destination: GW

Local source: node “a”.

The forwarding processing unit 16a outputs the generated data frame to the frame transmitting unit 17a. As illustrated in FIG. 10, the frame transmitting unit 17a transmits the data frame to the GW.

(P10) Subsequently, for example, the node “b” generates a data frame destined for the GW and transmits the generated data frame to the node “a” as in P8.

(P11) For example, before the node “a” receives the data frame transmitted from the node “b” in P10, a failure occurs in the node “a”.

(P12) If the application processing unit 14b in the node “b” is unable to conclude that the data frame is successfully transmitted to the GW within a predetermined period of time after transmission of the data frame to the node “a”, the application processing unit 14b determines that a failure occurs in the path to the GW via the node “a”. Accordingly, the application processing unit 14b requests the forwarding processing unit 16b to retransmit the data frame through a path via LD2.

(P13) The forwarding processing unit 16b refers to the routing table 22b and generates a data frame containing the following address information:

Global source: node “b”

Global destination: GW

Local destination: node “e”

Local source: node “b”.

The forwarding processing unit 16b outputs the generated data frame to the frame transmitting unit 17b. The frame transmitting unit 17b transmits the data frame to the node “e”.

Like the node “a” in P9, the node “e” outputs the frame destined for the GW, which has been received from the node “b”, to the node “f”. In addition, like the node “a” in P9, the node “f” transmits the frame to the GW.

As described above with reference to FIG. 8, through the processing described in P1 to P13, even when a failure occur in any one of the node devices 10 in the ad hoc network, a frame is transmitted to the global destination using another route that does not include a loop. Accordingly, wasted traffic is reduced in the ad hoc network and, thus, efficient communication may be performed. While transmission of a data frame generated in the node “b” has been described with reference to illustrated in FIGS. 8 and 10, a frame generated by another node device 10 and destined for the GW may be processed in the same manner.

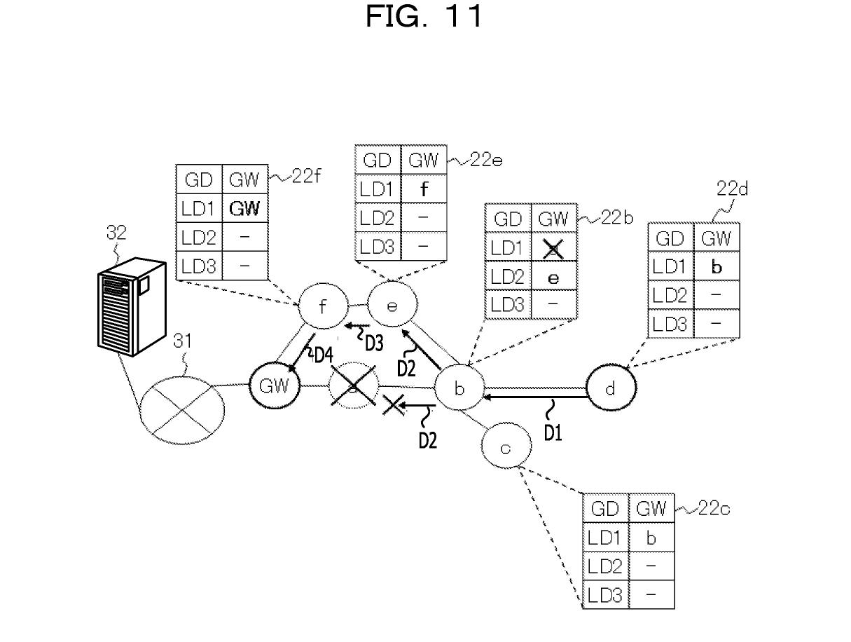

FIG. 11 illustrates an example of forwarding performed when a failure occurs in a node device 10. For example, a case is described below, in which a frame destined for the GW is transmitted from the node “d” after the node “b” detects that a failure occurs in the node “a” in P12 which is described with reference to FIG. 8. Note that D1 to D4 illustrated in FIG. 11 may be performed after P12. D1 to D4 may be performed simultaneously with P13.

(D1) When an application processing unit 14d in the node “d” outputs data destined for the GW to a forwarding processing unit 16d, the forwarding processing unit 16d refers to a routing table 22d and generates a frame having the global destination set to GW and the local destination set to the node “b”.

(D2) The application processing unit 14b in the node “b” acquires the frame generated in the node “d” via the frame receiving unit 11b and the frame information analyzing unit 12b. When the application processing unit 14b determines that the received frame is not destined for the node “b”, the application processing unit 14b outputs the frame to the forwarding processing unit 16b. At that time, the application processing unit 14b also notifies the forwarding processing unit 16b that the application processing unit 14b detects a failure occurring in the node “a”. Thus, the forwarding processing unit 16b determines that although the routing table 22b indicates that LD1 is the node “a” when the global destination is the GW, the forwarding processing unit 16b is unable to transfer the frame to the node “a”. Accordingly, the forwarding processing unit 16b sets the local destination to the node “e”, which is indicated by LD2, and adds, to the frame, the following address information:

Global source: node “d”

Global destination: GW

Local destination: node “e”

Local source: node “b”.

The node “b” forwards the frame destined for the GW and received from the node “d” to the node “e”.

(D3) The application processing unit 14e in the node “e” acquires the frame via a frame receiving unit 11e and a frame information analyzing unit 12e. Since the global destination of the frame is the GW, the application processing unit 14e outputs the frame to a forwarding processing unit 16e. The forwarding processing unit 16e refers to a routing table 22e and determines that the local destination of the frame is the node “f”. The frame is forwarded to the node “f”.

(D4) Like the node “e”, the node “f” transmits the frame received from the node “e” to the GW.

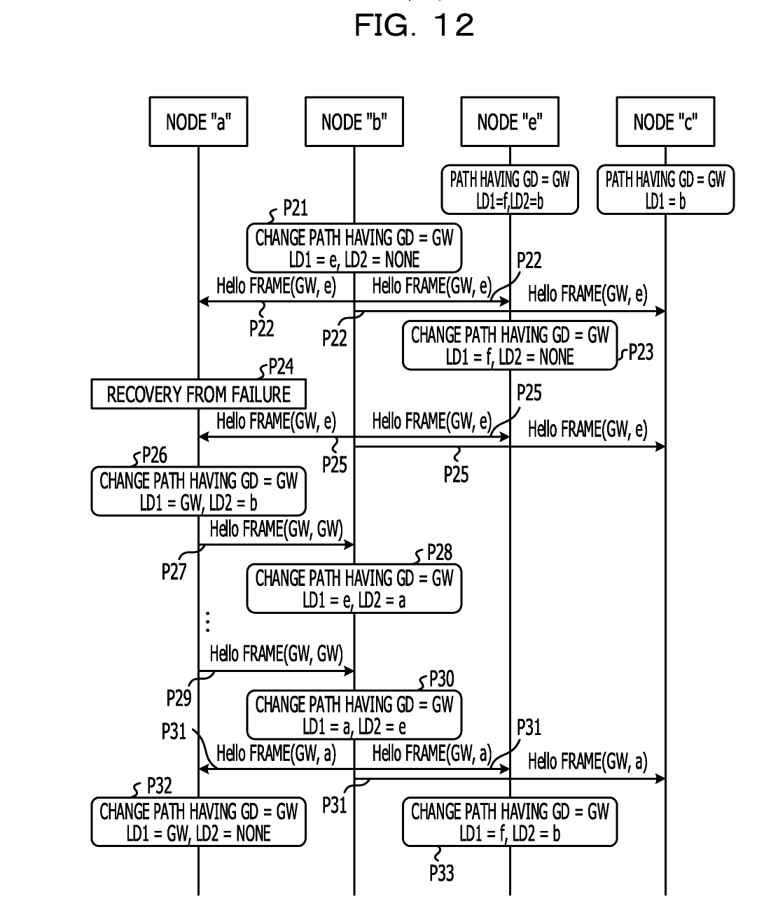

FIG. 12 is a sequence diagram illustrating an exemplary process performed when the forwarding path is changed. An example of changes in the path made when the node “a” failures and when the node “a” is recovered from the failure is described with reference to FIG. 12. Assume that, in the initial stage of FIG. 12, the node “e” has settings in which LD1 is set to node “f” and LD2 is set to node “b”. An example of the routing table 22e held in the node “e” is illustrated in FIG. 4B. In addition, in the node “c”, when the global destination is the GW, LD1 is the node “b”.

(P21) As illustrated in FIG. 11, if a failure occurs in the node “a”, the number of retransmissions from the node “b” to the node “a” increases. In addition, the node “b” is unable to receive the Hello frame from the node “a”. Thus, the path information processing unit 13b updates the link table 21b on the basis of the increase in the number of retransmissions and the difficulty in receiving the Hello frame. Furthermore, the path information processing unit 13b updates the evaluation value for the path via the node “a” due to the deterioration of the state of the link between the node “b” and the node “a”. If, after such processing, the evaluation value for the path from the node “b” to the GW via the node “a” is lower than the evaluation value for the path from the node “b” to the GW via the node “e”, then the path information processing unit 13b updates the path having the global destination set to the GW so that LD1 is changed to the node “e” and LD2 is changed to the node “a”.

If the node “a” is not recovered even after LD2 is set to the node “a”, the state of the link between the node “b” and the node “a” is further deteriorated. If the period of time during which the node “b” is unable to receive the Hello frame from the node “a” exceeds a predetermined value, the path information processing unit 13b deletes the entry for the node “a” from the link table 21b. In addition, the path information processing unit 13b deletes, from the routing table 22b, a path to the node “a” and a path having the local destination set to the node “a”. Accordingly, as illustrated in FIG. 12, in the path having GD=GW in the node “b”, LD1 is set to the node “e”, and the settings of LD2 are deleted.

(P22) When the time at which a Hello frame is generated is reached, the application processing unit 14b in the node “b” requests a Hello frame generating unit 15b to generate a Hello frame. The Hello frame generating unit 15b may notify a node device 10 that neighbors the node “b” that a frame having the global destination set to the GW is transmitted to the node “e”, using a Hello frame containing the following information items:

Source of the Hello frame: node “b”

Global destination contained in the Hello header: GW

LD1 contained in the Hello header: node “e”.

(P23) A path information processing unit 13e in the node “e” acquires the Hello frame generated in the node “b” via the frame receiving unit 11e and the frame information analyzing unit 12e. The path information processing unit 13e determines whether the path contained in the Hello frame received from the node “b” includes a loop. For example, the path information processing unit 13e determines whether a loop is included in the path to the GW via the node “e”, the node “b”, and the node “e”. At that time, since the local destination contained in the Hello header is the node “e”, the path information processing unit 13e determines that the path notified using the Hello header to be processed includes a loop.

Accordingly, in order to avoid recording the path including a loop, the path information processing unit 13e determines whether the path information indicated by the Hello header to be processed is included in the routing table 22e. As illustrated in FIG. 4B, the routing table 22e stores a path including GD=GW and LD2=node “b” in “No. 1-2” entry. Accordingly, as illustrated in FIG. 4C, the path information processing unit 13e deletes the entry including GD=GW and LD2=node “b” from the routing table 22e. That is, since the node “b” changes the path that is preferentially used for transmission of a frame destined for the GW, the node “e” updates the routing table 22e.

(P24) Subsequently, assume that the node “a” is recovered from the failure.

(P25) As in P22, the node “b” broadcasts a Hello frame containing information indicating GD=GW and LD1=node “e” to node devices 10 that neighbor the node “b”.

(P26) A path information processing unit 13a in the node “a” acquires the Hello frame generated in the node “b” via a frame receiving unit 11a and a frame information analyzing unit 12a. The path information processing unit 13a determines whether the path from the node “a” to the GW via the node “b” and the node “e” includes a loop. At that time, since the local destination contained in the Hello header is the node “e”, the path information processing unit 13a determines that the path notified using the Hello header to be processed does not include a loop. Accordingly, the path information processing unit 13a determines that a frame may be transmitted to the GW via the node “b” and, thus, records the path to the GW via the node “b” in the routing table 22.

In addition, the path information processing unit 13a identifies that the node “a” neighbors the GW using the Hello frame received from the GW. The path information processing unit 13a compares the path quality when a frame including GD=GW is transmitted to the GW with the path quality when the frame is forwarded to the node “b”. At that time, let the path quality when a frame including GD=GW is transmitted to the GW be higher. Then, the path information processing unit 13a sets the destinations of the frame destined for the GW so that LD1=GW and LD2=node “b”.

(P27) When the time at which a Hello frame is generated is reached, the application processing unit 14a in the node “a” requests a Hello frame generating unit 15a to generate a Hello frame. The Hello frame generating unit 15a may notify a node device 10 that neighbors the node “a” that a frame having the global destination set to the GW is transmitted to the GW, using a Hello frame containing the following information items:

Source of the Hello frame: node “a”

Global destination contained in the Hello header: GW

LD1 contained in the Hello header: GW.

(P28) The path information processing unit 13b in the node “b” registers the information regarding the node “a” in the link table 21b using the Hello frame transmitted from the node “a”. In addition, the path information processing unit 13b determines whether a loop is included in the path from the node “b” to the GW via the node “a” and the GW. At that time, since the local destination contained in the Hello header is not the node “b”, the path information processing unit 13b determines that a loop is not included in the path notified using the Hello header to be processed. Accordingly, the path information processing unit 13b determines that a frame may be transmitted to the GW via the node “a” and, thus, the path information processing unit 13b records the path to the GW via the node “a” in the routing table 22b. At that time, since the path to the GW in which LD1 is set to the node “e” has already been recorded in the routing table 22b, the node “a” is registered as LD2 of the path to the GW.

(P29) As in P27, the node “a” broadcasts the Hello frame.

(P30) The path information processing unit 13b in the node “b” updates the return path link weight between the node “b” and the node “a” and the observed value related to reception of a Hello frame using the Hello frame transmitted from the node “a”. In addition, the path information processing unit 13b updates the evaluation values for the paths in the routing table 22b in accordance with changes in the states of the links. At that time, let the quality of the path to the GW via the node “a” become higher than that of the path to the GW via the node “e”, since the Hello frame has been repeatedly transmitted and received between the node “b” and the node “a”. Then, the path information processing unit 13b makes the settings of the frame having GD=GW so that LD1 is set to the node “a” and LD2 is set to the node “e”.

(P31) In response to a request from the application processing unit 14b, the Hello frame generating unit 15b in the node “b” generates a Hello frame containing the following information items:

Source of the Hello frame: node “b”

Global destination contained in the Hello header: GW

LD1 contained in the Hello header: node “a”.

That is, the Hello frame generating unit 15b generates a Hello frame that may notify node devices 10 that neighbor the node “b” that a frame having the global destination set to the GW is transmitted to the node “a”.

(P32) Upon receiving the Hello frame generated in the node “b”, the path information processing unit 13a in the node “a” determines whether a loop is included in the path from the node “a” to the GW via the node “b” and the node “a”. In this case, since the local destination contained in the Hello header is the node “a”, the path information processing unit 13a determines that the path notified using the Hello header to be processed includes a loop.

Accordingly, in order to avoid recording the path including a loop, the path information processing unit 13a deletes the entry for the path having GD=GW and LD2=node “b” from the routing table 22a.

(P33) Upon acquiring the Hello frame generated in the node “b”, the path information processing unit 13e in the node “e” determines whether a loop is included in the path from the node “e” to the GW via the node “b” and the node “a”. In this case, since the local destination contained in the Hello header is the node “a”, the path information processing unit 13e determines that the path notified using the Hello header to be processed does not include a loop. Accordingly, the path information processing unit 13e registers the node “b” as LD2 of the path to the GW.

As described in P21 to P33, the node device 10 in the ad hoc network may update the routing table 22 when a neighboring node device 10 changes the forwarding path of a frame to the global destination. Accordingly, when the neighboring node device 10 changes the path, the node device 10 may dynamically changes the forwarding path of the frame. Thus, forwarding of the frame in a path including a loop may be avoided. In addition, if a node device 10 in which a failure has been occurred is recovered, forwarding of a frame using the path via the recovered node device 10 is resumed in accordance with the state of the path. Accordingly, a frame is efficiently forwarded in the ad hoc network.

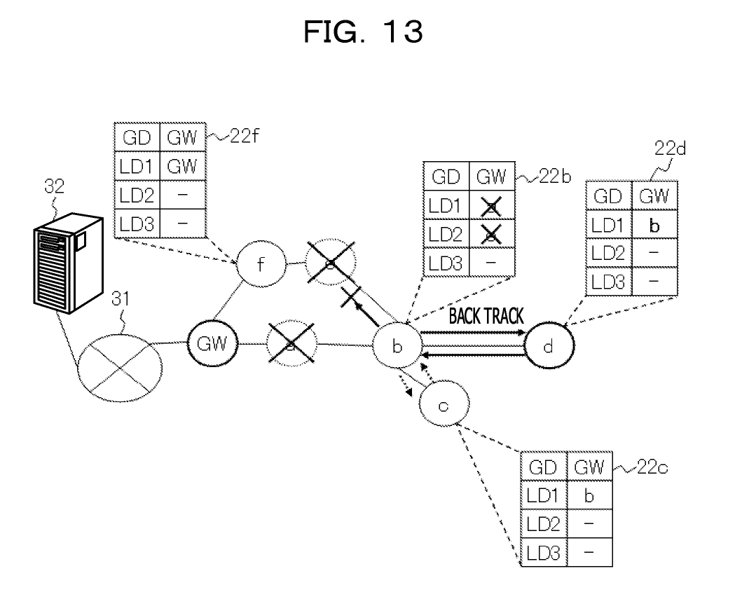

FIG. 13 illustrates an exemplary process performed when it is difficult to forward a frame. Assume that a failure occurs in the node “a” and the node “e” in the ad hoc network illustrated in FIG. 13 at the same time. Then, the node “b” performs the processing in P21 illustrated in FIG. 12 for both the node “a” and node “e” to unregister, from the routing table 22b, the path to GW. Thereafter, if the node “d” transmits a frame having the global destination set to the GW to the node “b”, then the application processing unit 14b requests the forwarding processing unit 16b to forward the frame received from the node “d”. However, since the path destined for the GW is unregistered from the routing table 22b, the forwarding processing unit 16b determines that it is difficult to forward the frame. Accordingly, the forwarding processing unit 16b forwards the frame to the local source (backtracking). At that time, the frame received by the node “b” from the node “d” is transmitted from the node “b” to the node “d”. When the node “d” detects that backtracking is performed, the node “d” determines that it is difficult to transmit the frame to the destination. Thus, the processing is completed. Note that in order to detect that backtracking is performed, the forwarding processing unit 16 of each of the node devices 10 holds correspondence information between an identification number for identifying a frame and the forwarding destination of the frame for each of frames.

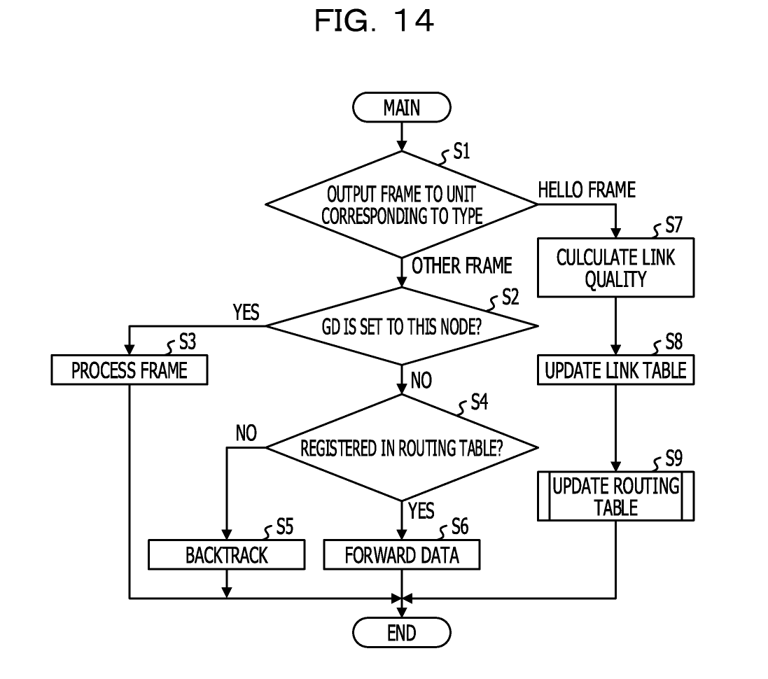

FIG. 14 is a flowchart illustrating an exemplary operation flow performed by the node device 10. The frame information analyzing unit 12 determines the type of a frame received via the frame receiving unit 11 and outputs the frame to the unit corresponding to the determined type (S1). When the input frame is a frame other than a Hello frame (“Other frame” in S1), the frame information analyzing unit 12 outputs the input frame to the application processing unit 14. The application processing unit 14 determines whether the input frame is destined for its own node (S2). When the global destination is its own node (“Yes” in S2), the application processing unit 14 processes the input frame (S3). When the global destination is not its own node (“No” in S2), the application processing unit 14 outputs the input frame to the forwarding processing unit 16. The forwarding processing unit 16 determines whether a path to the global destination of the frame has been registered in the routing table 22 (S4). When a path to the global destination of the frame has not been registered in the routing table 22 (“No” in S4), the forwarding processing unit 16 returns the frame to the local source of the frame (S5). When a path to the global destination of the frame has been registered in the routing table 22 (“Yes” in S4), the forwarding processing unit 16 determines the local destination and forwards the frame via the frame transmitting unit 17 (S6).

When the input frame is a Hello frame (“Hello frame” in S1), the frame information analyzing unit 12 outputs the input frame to the path information processing unit 13. The path information processing unit 13 calculates the link quality using, for example, the reception intervals and the signal strength of the received Hello frame (S7). The path information processing unit 13 updates the link table 21 (S8). In addition, the path information processing unit 13 updates the routing table 22 (S9).

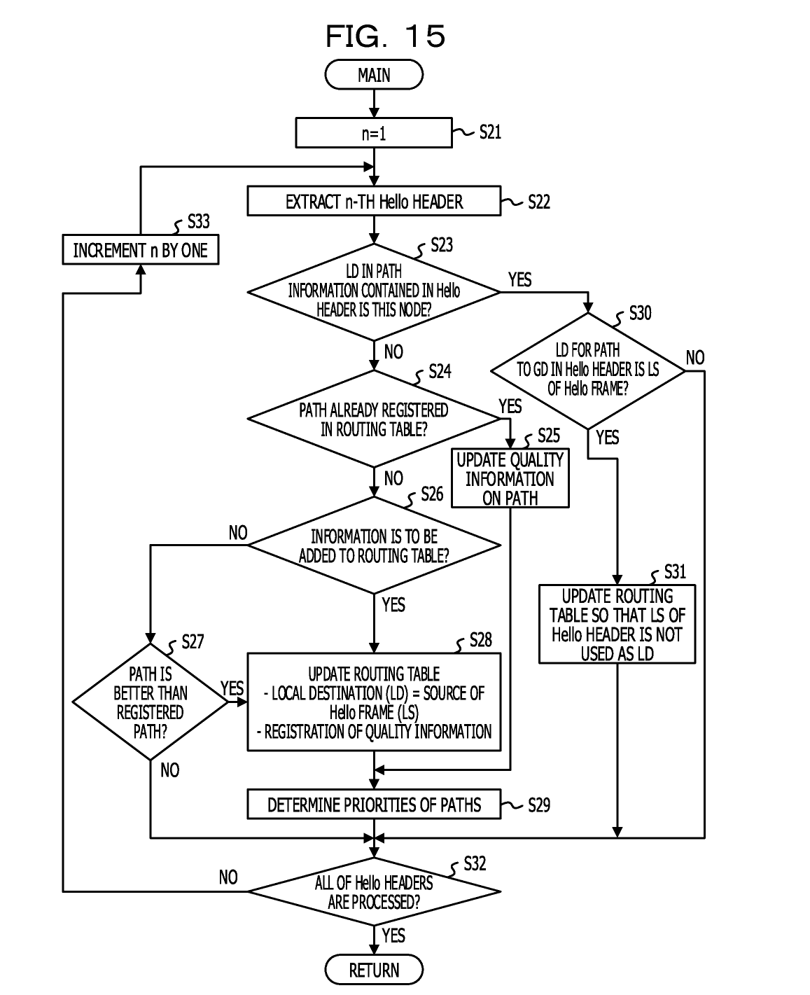

FIG. 15 is a flowchart illustrating an exemplary operation flow for updating the routing table 22. The path information processing unit 13 sets a variable n to 1 (S21). The path information processing unit 13 extracts an n-th Hello header from the Hello frame (S22). The path information processing unit 13 determines whether the local destination in the path information contained in the Hello header is its own node (S23).

When the local destination in the path information contained in the Hello header is not its own node (“No” in S23), the path information processing unit 13 determines whether the path notified using the Hello header to be processed has already been registered in the routing table 22 (S24). When the path notified using the Hello header to be processed has already been registered in the routing table 22 (“Yes” in S24), the path information processing unit 13 updates the quality information of the path notified using the Hello header (S25). When the path notified using the Hello header to be processed has not been registered, the path information processing unit 13 determines whether new path information is to be added to the routing table 22 (S26). When new path information is to be added to the routing table 22 (“Yes” in S26), the path information processing unit 13 records the path information notified using the Hello header to be processed in the routing table 22 (S28). That is, the path information processing unit 13 sets GD in the routing table 22 to the global destination address notified using the Hello header and sets the corresponding local destination address (LD) to the source of the Hello frame. Furthermore, the path information processing unit 13 registers the quality information regarding the path.

If a maximum number of local destinations that may be registered in association with a single global destination have already been registered, the determination made in S26 is “No”. Thereafter, the path information processing unit 13 determines whether the communication condition for the path notified using the Hello header to be processed is better than that for the path registered in the routing table 22 (S27). When the communication condition for the path notified using the Hello header to be processed is better than that registered in the routing table 22 (“Yes” in S27), the processing in S28 is performed for the notified path (S28). Note that in such a case, among the paths recorded in the routing table 22, the path having the worst condition is unregistered. After updating the information in the routing table 22 through S25 or S28, the path information processing unit 13 determines the priorities of the paths (S29). When the communication condition for the path notified using the Hello header to be processed is worse than that for the path registered in the routing table 22 (“No” in S27), the path information processing unit 13 does not register the path notified using the Hello header in the routing table 22.

When the local destination in the path information contained in the Hello header is its own node (“Yes” in S23), the path information processing unit 13 determines whether the path notified using the Hello header to be processed has already been registered in the routing table 22 (S30). At that time, the path information processing unit 13 determines whether the source of the Hello frame is included in the routing table 22 as the forwarding destination for the path to the node device 10 set as GD in the Hello header. When the source of the Hello frame is included as the forwarding destination for the path to GD in the Hello header (“Yes” in S30), the path information processing unit 13 unregisters the path from the routing table 22 (S31).

After the processing in S21 to S31 is completed, the path information processing unit 13 determines whether all of the Hello headers included in the Hello frame have been processed (S32). When some of the Hello headers included in the Hello frame have not yet been processed (“No” in S32), the path information processing unit 13 increments n by one (S33). Thereafter, the path information processing unit 13 repeats the processing in S22 and the subsequent processing. When all of the Hello headers included in the Hello frame have been processed (“Yes” in S32), the path information processing unit 13 completes its processing.

According to the first embodiment, even when failure occurs in any one of the node devices 10 in the ad hoc network, a frame is transmitted to the global destination using a route that does not include a loop by the processing described with reference to FIG. 8. In addition, by the processing described with reference to FIG. 12, the node device 10 updates the routing table 22 in response to a change in the forwarding path in a neighboring node device 10. In this manner, the occurrence of a loop in the forwarding path of the frame due to the change in the path in the neighboring node device 10 may be avoided. Furthermore, when the failed node device 10 is recovered, transmission of a frame using a path via the recovered node device 10 is resumed. Accordingly, a frame is efficiently transmitted in the ad hoc network.

According to the first embodiment, each of the node devices 10 generates the routing table 22 so that a node device 10 from which each of the node devices 10 may receive a frame is not set as the destination of the frame. Accordingly, a frame transmitted from a node device 10 is forwarded to the final destination without passing through the same node device 10 again. In this manner, according to the first embodiment, wasted traffic is reduced in the ad hoc network and, thus, the wireless resources may be efficiently used. Furthermore, since the occurrence of congestion in the ad hoc network may be avoided, the stability of the whole system may be increased.

### Second Embodiment

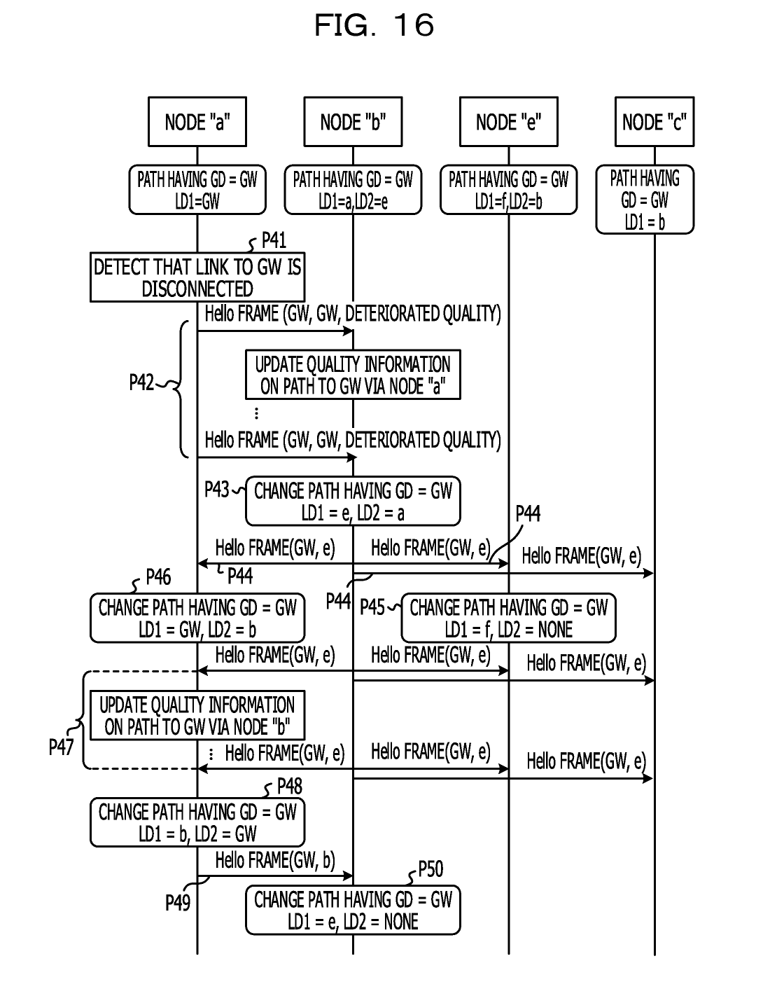

FIG. 16 is a sequence diagram illustrating an exemplary process performed in a second embodiment. In the second embodiment, an example of the process performed when a node device 10 that neighbors another node device 10 that detects deterioration of the state of a path transmits a frame so that the other node device 10 is avoided is described.

In the second embodiment, a Hello frame is communicated and the routing table 22 is generated in the same manner as in the first embodiment. At start of the process illustrated in FIG. 16 the followings are assumed when the global destination is the GW. In the node “b”, LD1 is the node “a” and LD2 is the node “e”. In the node “e”, LD1 is the node “f” and LD2 is the node “b”. In the node “a”, LD1 is the GW. In the node “c”, LD1 is the node “b”.

(P41) The application processing unit 14a in the node “a” detects that a link to the GW is disconnected. Since the link is disconnected, the path information processing unit 13a updates a link table 21a and the routing table 22a.

(P42) Upon receiving a request from the application processing unit 14a, the Hello frame generating unit 15a in the node “a” generates a Hello frame containing the following information items:

Source of the Hello frame: node “a”

Global destination in the Hello header: GW

LD1 in the Hello header: GW

Quality information in the Hello header: Deteriorated quality.

That is, the Hello frame generating unit 15a generates a Hello frame that may notify a node device 10 that neighbors the node “a” that a frame having the global destination set to GW is transmitted to the GW and the quality of the path to the GW via the node “a” is deteriorated.

The path information processing unit 13b in the node “b” updates the information regarding the quality of the path to the GW via the node “a” on the basis of the Hello frame received from the node “a”.

Subsequently, the node “a” continuously notify the node device 10 that neighbors the node “a” that the quality of the path to the GW via the node “a” is deteriorated using the Hello frame until the link to the GW is recovered. In the node “b”, the quality information in the routing table 22b is continuously updated.

(P43) Assume that in the node “b”, the quality of the path to the GW via the node “e” becomes better than the quality of the path to the GW via the node “a”, since the path information processing unit 13b continuously updates the quality information in the routing table 22b. Then, the path information processing unit 13b changes LD1 to the node “e” and LD2 to the node “a” for the path having GD=GW.

(P44) Upon receiving a request from the application processing unit 14b, the Hello frame generating unit 15b in the node “b” generates a Hello frame containing the following information items:

Source of the Hello frame: node “b”

Global destination in the Hello header: GW

LD1 in the Hello header: node “e”.

By using the Hello frame, the node “b” notifies node devices 10 that neighbor the node “b” that a frame having the global destination set to GW is transmitted to the node “e”.

(P45) The path information processing unit 13e in the node “e” acquires the Hello frame generated in the node “b”. Since the local destination in the Hello header is the node “e”, the path information processing unit 13e determines that the path notified using the Hello header to be processed includes a loop.

Accordingly, to avoid recording the path including a loop, the path information processing unit 13e unregisters the information regarding a path that uses the path notified using the Hello header to be processed from the routing table 22e. Therefore, the node “e” does not change the information of LD1 in the frame destined for the GW (i.e., LD1=node “f”) and deletes the information of LD2.

(P46) The path information processing unit 13a in the node “a” acquires the Hello frame generated in the node “b”. Since the local destination in the Hello header is the node “e”, the path information processing unit 13a determines that the path notified using the Hello header to be processed does not include a loop. The path information processing unit 13a determines that a frame may be transmitted to the GW via the node “b” and, thus, records the path to the GW via the node “e” in the routing table 22. In this manner, LD1=GW and LD2=node “b” are recorded in the routing table 22a as the forwarding destination of a frame destined for the GW.

(P47) The node “b” continuously transmits the Hello frame as described in P44. Each time the node “a” receives the Hello frame from the node “b”, the node “a” updates the quality information regarding the path to the GW via the node “b”.

(P48) Assume that in the node “a”, the quality of the path to the GW via the node “b” becomes better than the quality of the path from the node “a” to the GW, since the path information processing unit 13a continuously updates the quality information in the routing table 22a. Then, the path information processing unit 13a changes LD1 to the node “b” and LD2 to the GW.

(P49) Upon receiving a request from the application processing unit 14a, the Hello frame generating unit 15a in the node “a” generates a Hello frame containing the following information items:

Source of the Hello frame: node “a”

Global destination in the Hello header: GW

LD1 in the Hello header: node “b”.

By using the Hello frame, the node “a” notifies a node device 10 that neighbors the node “a” that a frame having the global destination set to GW is transmitted to the node “b”.

(P50) The path information processing unit 13b in the node “b” acquires the Hello frame generated in the node “a”. Since the local destination in the Hello header is the node “b”, the path information processing unit 13b determines that the path notified using the Hello header to be processed includes a loop.

Accordingly, to avoid recording the path including a loop, the path information processing unit 13b unregisters the information regarding a path that uses the path notified using the Hello header to be processed from the routing table 22b. Therefore, the node “b” does not change the information of LD1 in the frame destined for the GW (i.e., LD1=node “e”) and deletes the information of LD2.

Assume that at the end of the processing in P50, a frame having the global destination set to the GW is generated in the node “a”. Then, the frame generated in the node “a” is transmitted from the node “a” to the GW via the node “b”, the node “e”, and the node “f”.

As described above, according to the second embodiment, by using a Hello frame, the node device 10 that detects a failure, such as link disconnection, notifies the neighboring node devices 10 that the quality of the path is deteriorated so that the path via the node device 10 is less selected. Thus, according to the second embodiment, a path including a link having a deteriorated quality is less selected. In addition, like the first embodiment, by selecting a path registered in the routing table 22, a node device 10 may transmit a frame to the global destination without receiving the transmitted frame again from a node device 10 to which the transmitted frame has been forwarded. As a result, communication is efficiently performed.

According to the second embodiment, even when a link is temporarily disconnected due to a variation in a wireless environment, the probability of a frame reaching the final destination may be increased. Like the first embodiment, in the second embodiment, if the disconnected link is recovered, the Hello frame having excellent quality information recorded therein is communicated several times. In this manner, the communication path employed before the link disconnection may be recovered.

### Other Embodiments

Note that embodiments are not limited to the above-described embodiments. A variety of modifications may be made. Some of the modifications are described below.

The first embodiment may be combined with the second embodiment. The information items contained in the link table 21 and the routing table 22 may be changed in accordance with the implementation. Similarly, the format of the frame may be changed in accordance with the implementation.

While the examples of the operation above have been described with regard to a frame having a global destination set to a node device 10 that functions as a gateway for relaying communication between the ad hoc network and another network, any one of the node devices 10 in the ad hoc network may be specified as the global destination. Even when any one of the node devices 10 is specified as the global destination, a path including a loop is not registered in the routing table 22 by using the above-described technique.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication method comprising:
transmitting, by a first node device, a first path information frame including first path information that associates a destination node device with a first forwarding destination to which the first node device forwards a data frame destined for the destination node device;
receiving the first path information frame by a second node device other than the first node device;
determining, by the second node device, whether a forwarding path includes a loop, the forwarding path being a path from the second node device to the destination node device via the first node device and the first forwarding destination;
storing, by the second node device, the first path information upon determining that the forwarding path does not include a loop; and
forwarding, by the second node device, a data frame destined for the destination node device to the first node device on the basis of the first path information.

2. The communication method according to claim 1, wherein the second node device has a routing table for storing the first path information, the communication method further comprising:
determining by the second node device, upon determining that the forwarding path includes a loop, whether the first node device has been registered in the routing table, as a second forwarding destination to which the second node device forwards a data frame destined for the destination node device; and
unregistering by the second node device, upon determining that the first node device has been registered as the second forwarding destination, the first node device registered as the second forwarding destination.

3. The communication method according to claim 1, wherein
the second node device determines, when the first forwarding destination is the second node device, that the forwarding path includes a loop.

4. The communication method according to claim 1, wherein
the first path information frame specifies a third node device as the first forwarding destination,
the first path information frame further includes first quality information indicating a first quality of a first path from the first node device to the destination node device via the third node device,
the second node device determines, upon receiving the first path information frame, the first node device as a first candidate for a second forwarding destination to which the second node device forwards a data frame destined for the destination node device,
the second node device receives, from a fourth node device, second path information frame including second path information that associates the destination node device with a fifth node device to which the fourth node device forwards a data frame destined for the destination node device,
the second path information frame further includes second quality information indicating a second quality of a second path from the fourth node device to the destination node device via the fifth node device,
the second node device determines, upon receiving the second path information frame, the fifth node device as a second candidate for the second forwarding destination, and
the second node device selects, when the first quality is better than the second quality, the first node device as the second forwarding destination.

5. The communication method according to claim 4, wherein
the first node device transmits, when a failure occurs in communication between the first node device and the third node device, a third path information frame including the first path information and third quality information indicating a third quality of the first path, the third quality being worse than the first quality,
the second node device compares, upon receiving the third path information frame, the third quality with the second quality, and
the second node device changes, when the third quality is worse than the second quality, the second forwarding destination from the first node device to the fourth node device.

6. The communication method according to claim 5, wherein
the second node device transmits, while forwarding data frames destined for the destination node device through the first path, a fourth path information frame including third path information that associates the destination node device with the first node device to which the second node device forwards a data frame destined for the destination node device,
the first node device does not use, upon receiving the fourth path information frame, the second node device as the first forwarding destination of a data frame destined for the destination node device,
the second node device transmits, upon changing the second forwarding destination from the first node device to the fourth node device, a fifth path information frame including fourth path information that associates the destination node device with the fourth node device to which the second node device forwards a data frame destined for the destination node device, and
the first node device determines, upon receiving the fifth path information frame, the second node device as a candidate for the first forwarding destination.

7. A computer-readable recording medium storing a program that causes a computer to execute a procedure, the procedure comprising:
receiving a path information frame from a node device, the path information frame including path information that associates a destination node with a forwarding destination to which the node device forwards a data frame destined for the destination node;
determining whether a forwarding path includes a loop, the forwarding path being a path from the second node device to the destination node device via the first node device and the first forwarding destination;
storing the path information upon determining that the forwarding path does not include a loop; and
forwarding a data frame destined for the destination node to the node device on the basis of the path information.

8. A node device comprising:
a processor configured to
receive a path information frame from a neighboring node, the path information frame including path information that associates a destination node with a forwarding destination to which the neighboring node forwards a data frame destined for the destination node,
determine whether a forwarding path includes a loop, the forwarding path being a path from the second node device to the destination node device via the first node device and the first forwarding destination,
store the path information upon determining that the forwarding path does not include a loop, and
forward a data frame destined for the destination node to the neighboring node on the basis of the path information.
